(19) United States
(12) Patent Application Publication
(10) Pub. No.: US 2026/0169454 A1
(43) Pub. Date: Jun. 18, 2026

(54) REGULATOR DEVICE, REGULATOR UNIT, AND METHOD

(71) Applicant: FESTO SE & CO. KG, Esslingen (DE)

(72) Inventor: Valentin FALKENHAHN, Neulußheim (DE)

(21) Appl. No.: 18/854,200

(22) PCT Filed: Apr. 3, 2023
(86) PCT No.: PCT/EP2023/058676

§ 371 Date: Oct. 4, 2024

(30) Foreign Application Priority Data
Apr. 4, 2022 (DE) 10 2022 107 930.9

(51) Int. Cl. G05B 19/042; F16K 37/00; G05B 13/02

(52) U.S. Cl. CPC G05B 19/0428; F16K 37/0041; G05B 13/024; G05B 2219/45006

(57) ABSTRACT

A regulator device for automation technology for actuating a valve device in order to provide regulation of a controlled variable to a setpoint of a setpoint signal. The regulator device has at least one regulator parameter, for example a regulator amplification, on the basis of which the regulation is performed, and the regulator device is designed to detect an oscillation of the controlled variable during the regulation, to classify the detected oscillation into one of a plurality of oscillation classes, and, depending on the oscillation class into which the detected oscillation is classified, to perform a regulator parameter adjustment of the at least one regulator parameter in order to reduce or eliminate the oscillation.

The invention relates to a controller device for automation technology, for the control of a valve device, in order to provide a closed-loop control of a controlled variable to a setpoint of a setpoint signal, wherein the controller device comprises at least one controller parameter, for example a controller amplification, on the basis of which the closed-loop control is effected, and wherein the controller device is designed to detect an oscillation of the controlled variable during the closed-loop control.

EP 2 356 522 B 1 describes a method for the closed-loop control of a control system which is closed-loop controlled by a control device, wherein the control device provides the control input to at least one control unit in the system, e.g. to a valve. The method comprises a detecting of an oscillation level in the control input into the control unit and an amplifying of the control input by a multiplication factor on the basis of the detected oscillation level.

An object of the invention is to provide a flexibly usable controller device. This object is achieved by a controller device according to claim 1. The controller device is designed to classify the detected oscillation into one of several oscillation classes and in dependence on the oscillation class into which the detected oscillation is classified, to carry out a controller parameter adaptation of the at least one controller parameter, in order to reduce or eliminate the oscillation.

In this manner it is possible to use the controller device for applications concerning which various causes for the oscillations of the controlled variable—and herewith different oscillation classes—can occur, and to effectively reduce or eliminate the oscillation—if necessary—by way of the controller parameter adaptation according to the respective cause for the oscillation. Depending on the causes for the oscillations, different controller parameter adaptations can be necessary in order to achieve a reduction or elimination of the oscillations. Furthermore, it is possible for one or more causes for an oscillation to require no controller parameter adaptation, i.e. when the oscillation is set or when the oscillation cannot be reduced or eliminated by a controller parameter adaptation. By way of the classification of the detected oscillation into one of the several oscillation classes, it is possible in a targeted—and therefore effective manner—to react to the respectively present cause of the detected oscillation.

Since the controller device can reduce or eliminate an occurring oscillation, it is basically not necessary to design the closed-loop control in a stable manner over the whole setpoint region—which would typically necessitate the closed-loop control being designed in a defensive, thus slow manner or the setpoint region being limited. The closed-loop control can therefore be designed rapidly over a large setpoint region. Inasmuch as an instability of the closed-loop control—thus an oscillation—occurs for a certain setpoint, this can be reduced or eliminated by a (in particular valid for this setpoint) controller parameter adaptation, in particular without the closed-loop control being adapted, for example set more defensively, for the remaining setpoint region (in which no oscillation occurs).

Advantageous further developments are the subject-matter of the dependent claims.

The invention further relates to a controller appliance, comprising the controller device and the valve device.

The invention further relates to a method for operating the controller device or the controller appliance, comprising the steps: providing the closed-loop control of the controlled variable to the setpoint on the basis of the at least one controller parameter, detecting an oscillation of the controlled variable, classifying the detected oscillation into one of several oscillation classes, and in dependence on the oscillation class into which the detected oscillation is classified, carrying out the controller parameter adaptation.

Further exemplary details as well as exemplary embodiments are hereinafter explained with reference to the figures. Herein are shown in:

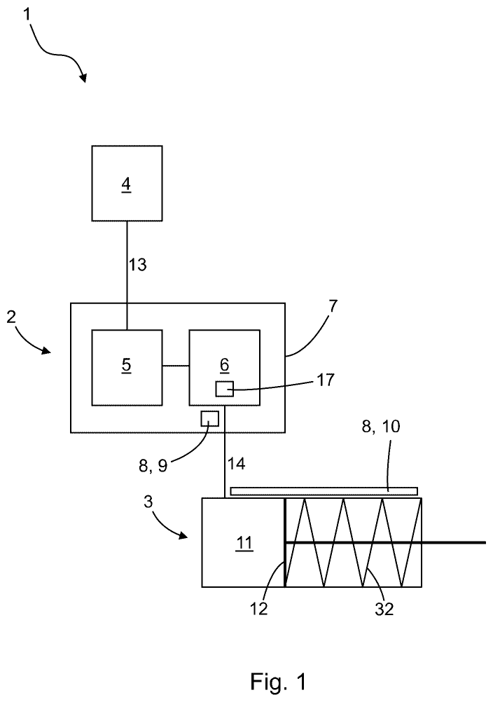

FIG. 1 a schematic representation of a system,

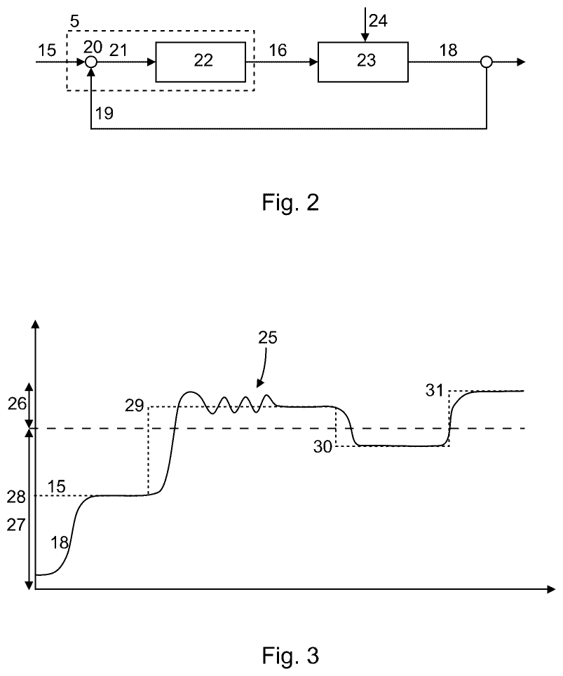

FIG. 2 a block diagram of a control circuit,

FIG. 3 an illustratory picture with a temporal course of a controlled variable and a temporal course of a setpoint signal,

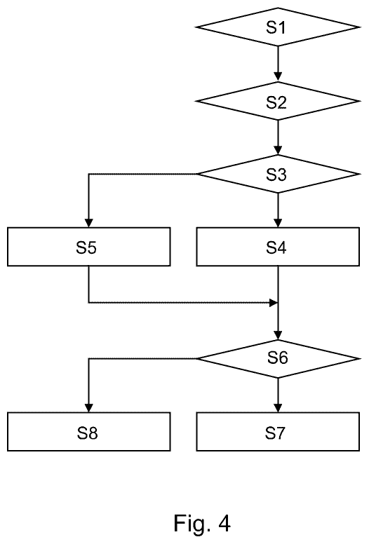

FIG. 4 a flow diagram of a method for the operation of a controller device.

FIG. 1 shows a system 1 which comprises a controller appliance 2 and a fluidic actuator 3. Optionally, the system 1 further comprises a super-ordinate control 4. The controller appliance 2 comprises a controller device 5 and expediently further a valve device 6. Alternatively, the valve device 6 can be provided outside the controller appliance 2. The system represents an exemplary application environment for the controller appliance 2, in particular the controller device 5. The controller appliance 2, in particular the controller device 5 can also be provided on its own—thus in particular without the other components of the system 1.

The controller appliance 2 is designed for example as a universal control valve. The controller appliance 2 in particular can be designed and/or operated as a pressure control valve, mass flow control valve, force control valve and/or a valve with an integrated positioning algorithm. The controller appliance 2 can be designed as an individual valve, as a valve on a valve terminal or as a valve terminal. Moreover, the controller device 2 can be designed as a positioner.

The controller appliance 2 expediently has setting possibilities on the part of the user, for example by way of a selection of parameter sets and/or by way of setting individual parameters to which the user has access, in particular by way of a user interface.

The controller appliance 2 expediently comprises a housing 7. By way of example, the controller device and/or the valve device 6 are accommodated in the housing 7.

By way of example, the system 1 comprises a sensor device 8. The sensor device 8 by way of example comprises a pressure sensor unit 9 and/or a position sensor unit 10. The pressure sensor unit 9 in particular serves for detecting a pressure of a pressure chamber 11 of the fluidic actuator 3. By way of example, the pressure sensor unit 9 is part of the controller appliance and in particular is accommodated in the housing 7. The position sensor unit 10 in particular serves for detecting a position of an actuator element 12 of the fluidic actuator 3. The position sensor unit 10 is expediently arranged on the fluidic actuator 3.

The super-ordinate control 4 is designed for example as a programmable logic control thus as a PLC. The super-ordinate control 4 is expediently communicatively connected to the controller appliance 2 via a communication connection 13, in particular a field bus. The superordinate control 4 expediently serves for providing a setpoint signal 15 to the controller appliance 2, according to which setpoint signal the controller appliance 2 carries out a closed-loop control of the fluidic actuator 3.

The fluidic actuator 3 by way of example is designed as a drive cylinder. In particular, the fluidic actuator 3 is a pneumatic actuator. The fluidic actuator 3 comprises the fluidically actuatable actuator element 12 which in particular is designed as a piston. The fluidic actuator 3 comprises the pressure chamber 11 which can be subjected to a fluid pressure, in particular compressed air, in order to actuate the actuator element 12. By way of example, the fluidic actuator 3 is designed as a single-acting fluidic actuator and comprises a spring element 32 which acts upon the actuator element 12. The fluidic actuator 3 can further be designed as a dual-acting fluidic actuator. Furthermore, the fluidic actuator can be designed as a valve drive or as a valve. The fluid actuator 3, in particular the pressure chamber 11 is expediently fluidically connected to the controller appliance 2, in particular to the control device 6, via a fluid conduit 14, in particular a hose.

The controller device 5 expediently comprises a microcontroller or is designed as a microcontroller. The controller device 5 provides the setpoint signal 15. For example, the controller device 5 receives the setpoint signal 15, in particular from the superordinate control 4, or the controller device 5 computes the setpoint signal 15 itself. On the basis of the setpoint signal 15, the controller device 5 computes a control signal 16 for the control of the valve device 6. The control signal 16 is preferably an electrical control signal.

The valve device 6 is preferably designed as an electro-fluidic, in particular electro-pneumatic transducer or comprises an electro-fluidic, in particular electro-pneumatic transducer. The valve device 6 comprises a valve element 17 and is expediently designed, on the basis of the control signal 16, to actuate, in particular position the valve element 17. Preferably, the valve device 6 is designed to provide a fluid signal according to the control signal 16, said fluid signal by way of example being fed to the pressure chamber 11.

The controller device 5, in particular the controller appliance 2 expediently serves for the application in automation technology, in particular industrial automation. For example, an industrial facility is provided and the controller device 5, in particular the controller appliance 2, preferably the system 1 is part of the industrial facility.

The controller device 5 serves for the control of the valve device 6 in order to provide a closed-loop control of a controlled variable 18 to a setpoint of the setpoint signal 15. The controlled variable 18 by way of example includes a pressure, a mass flow, a force and/or a position. The controlled variable 18 preferably includes the pressure of the pressure chamber 11 and/or the position of the actuator element 12.

FIG. 2 shows a block diagram of an exemplary control circuit, according to which the closed-loop control can be effected.

Expediently, the controlled variable 18 is measured by the sensor device 8, in particular the pressure sensor unit 9 and/or the position sensor unit 10 and is fed to the controller device 5 as a feedback variable 19. The controller device 5 expediently comprises a subtraction element 20 which computes a control deviation 21 as a difference between the setpoint signal 15 and the feedback variable 19. The controller device 5 expediently comprises a controller unit 22 which computes the control signal 16 on the basis of the control deviation 21. The subtraction element 20 and/or the controller unit 22 are expediently implemented in the software. The controller unit 22 preferably comprises at least one proportional element for computing the control signal 16. The controller unit 22 is designed for example as a PID-controller or as a PI-controller or comprises (for the computation of the control signal 16) a PID-controller and/or a PI-controller. Moreover, the controller unit 22 can comprise a controller model for computing the control signal 16.

The control signal 16 expediently serves as a command variable for a control path 23 which by way of example comprises the valve device 6 and/or the actuator 3. The controlled variable 18 sets in at the control path 23 according to the control signal 16 and/or a disturbance variable 24.

The controller device 5 comprises at least one controller parameter, on the basis of which the closed-loop control is effected. Expediently, the controller device comprises several controller parameters, on the basis of which the closed-loop control is effected. The controller device 5 computes the control signal 16 on the basis of the setpoint signal and the feedback variable 19 amid the use of the one or more controller parameters. The at least one controller parameter is for example an amplification factor of the proportional element. The one or more controller parameters are for example controller parameters of the PID-controller, PI-controller and/or the controller model of the controller unit 22. For example, the one or the more controller parameters are controller amplifications of the controller unit 22.

The controller device 5 is designed, during the closed-loop control, to detect an oscillation 25 of the controlled variable 18. What is meant by the detection of the oscillation 25 in particular is a recognition of the oscillation 25 by the controller device 5. The detected oscillation 25 can also be denoted as a recognised oscillation. 15. Expediently, the controller device 5 detects the oscillation 25 on the basis of a sensor signal which is provided by the sensor device 8, in particular the pressure sensor unit 9 and/or the position sensor unit 10, said sensor signal mapping the controlled variable 18. The sensor signal for example represents the feedback variable 19. The oscillation 25 in particular is a periodic oscillation. The controller device 5 expediently comprises an oscillation recognition function, in order to recognise the oscillation 25. For example, the controller device 5 is designed to carry out a frequency analysis, for example a Fourier transformation, in particular on the basis of the controlled variable 18, the feedback variable 19 and/or the control deviation 21, in order to recognise the oscillation 25. The controller device 5 is expediently designed to provide oscillation information on the basis of the recognised oscillation 25, said information indicating the recognised oscillation 25.

The oscillation 25 in particular is an unwanted oscillation. For example, the oscillation 25 occurs in an edge region (in particular of the controlled variable 18) and/or in a special case, for example given particular environmental conditions. The oscillation 25 in particular occurs given a constant setpoint of the setpoint signal 15, thus in particular given a constant setpoint specification.

The controller device 5 expediently detects (and in particular recognises) the oscillation 25 online—thus in particular on normal operation of the controller device 5. In normal operation, the controller device 5 carries out the closed-loop control for a purpose other than the pure detection of the oscillation 25. For example, the controller device 5 carries out the closed-loop control in normal operation for the purpose of an industrial process, in particular an industrial manufacturing process.

The controller device 5 is preferably designed to recognise the oscillation 25 in a stationary state of the setpoint signal 15—thus given a constant setpoint. In particular, the controller device 5 is designed to recognise the oscillation 25 only in the stationary state of the setpoint signal 15. For example, the controller device 5 examines whether the stationary state of the setpoint signal 15 is present and only carries out the recognition of the oscillation 25 when the stationary state is present. The stationary state in particular is given when a certain time duration has elapsed since the last change of the setpoint.

The controller device 5 is further designed to classify the detected oscillation 25 into one of several oscillation classes. That oscillation class into which the controller device 5 classifies the detected oscillation 25 it also to be denoted as the present oscillation class or as the detected oscillation class of the detected oscillation 25. The several oscillation classes are expediently defined in the controller device 5. The several oscillation classes expediently differ in the cause of the oscillations and/or in the type of controller parameter adaptation for reducing or eliminating the oscillations. The controller device 5 is preferably designed, on the basis of the detected oscillation class of the oscillation 25, to provide oscillation information which indicates the detected oscillation class.

The controller device 5 is preferably designed to carry out the classification of the detected oscillation 25 on the basis of oscillation characteristics of the detected oscillation 25, for example on the basis of a spectrum, in particular a frequency, a phase and/or an amplitude of the detected oscillation 25. Moreover, the controller device 5 can be designed, on classification of the detected oscillation 25, to take into account a reference oscillation characteristic (stored for example in the controller device 5). In particular, for the classification of the detected oscillation 25, the controller device 5 is designed to compare the oscillation characteristic of the detected oscillation 25 with one or more reference oscillation characteristics (which are expediently stored in the controller device 5). For example, a respective reference oscillation characteristic is stored in the controller device 5 for each defined oscillation class. For the classification of the detected oscillation 25, the controller device 5 is preferably designed to take into account the setpoint signal 15, in particular an oscillation characteristic of the setpoint signal 15, for example a spectrum, in particular a frequency, a phase and/or an amplitude of the setpoint signal 15. For the classification of the detected oscillation 25, the controller device 5 in particular is designed to compare the oscillation characteristic of the detected oscillation 25 with an oscillation characteristic of the setpoint signal 15.

By way of example, the oscillation classes comprise a setpoint oscillation class, a sensor noise oscillation class, a stability reserve oscillation class and/or a disturbance oscillation class.

The controller device 5 is preferably designed to detect that the detected oscillation 25 is caused by a setpoint oscillation, and as a response to this detection to classify the detected oscillation 25 into the setpoint oscillation class. For example, the controller device 5 is designed to detect a setpoint oscillation of the setpoint signal 15 and on the basis of a comparison of the detected oscillation 25 with the setpoint oscillation to detect that the detected oscillation 25 is caused by the setpoint oscillation, in particular as a response to a frequency of the setpoint oscillation being equal to a frequency of the detected oscillation 25.

The controller device 5 is preferably designed to detect that the detected oscillation 25 is caused by a sensor noise, and as a response to this detection to classify the detected oscillation 25 into the sensor noise oscillation class. For example, the controller device 5 is designed, by way of an amplitude of the detected oscillation 25, to detect that the detected oscillation is caused by the sensor noise, in particular as a response to the amplitude being smaller than a predefined amplitude threshold value. Moreover, the controller device 5 can be designed, whilst taking into account a stored (in particular in the controller device 5) sensor noise characteristic, for example sensor noise spectrum, to detect that the detected oscillation 25 is caused by the senor noise, in particular by way of the controller device comparing the sensor noise characteristic with an oscillation characteristic, in particular a spectrum, of the detected oscillation 25.

Preferably, the controller device 5 is designed to detect that the detected oscillation is caused by too low a stability reserve of the closed-loop control, and as a response to this detection to classify the detected oscillation into the stability reserve oscillation class. In particular, the controller device 5 is designed to determine the stability reserve of the closed-loop control, for example on the basis of one or more of the controller parameters, in particular controller amplifications, of the closed-loop control, in particular of the controller unit 22. Expediently, the controller device 5 is designed to compare the stability reserve with a stability reserve threshold value and on the basis of the comparison to detect that the detected oscillation 25 is caused by too low a stability reserve, in particular when the stability reserve is lower than the stability reserve threshold value. Moreover, the controller device 5 can be designed, on the basis of a reference oscillation characteristic which is stored in the controller device 5 and which is assigned to the stability reserve oscillation class, to detect that the detected oscillation 25 is caused by a stability reserve which is too low.

The controller device 5 is preferably designed to detect that the detected oscillation 25 is caused by an external disturbance and as a response to this detection to classify the detected oscillation 25 into the disturbance oscillation class. For example, the controller device 5 classifies the detected oscillation 25 into the disturbance oscillation class as a response to the controller device 5 detecting that the detected oscillation 25 does not belong in one, several or all of the other oscillation classes, for example of the setpoint oscillation class, of the sensor noise oscillation class and/or of the stability reserve oscillation class. Moreover, the controller device 5 can be designed, on the basis of a reference oscillation characteristic which is stored in the controller device 5 and which is assigned to the disturbance oscillation class, to detect that the detected oscillation 25 is caused by an external disturbance.

The controller device 5 is preferably designed, in dependence on the oscillation class into which the detected oscillation 25 is classified, to carry out a controller parameter adaptation of the at least one controller parameter. In particular, the controller device 5 is designed to carry out the controller adaptation in order to reduce or eliminate the oscillation. Expediently, on controller parameter adaptation, the controller device 5 adapts several controller parameters, in particular several controller amplifications, in particular in dependence on the detected oscillation class.

For example, a respective controller parameter adaptation is assigned to each oscillation class. Controller parameter adaptations which are assigned to different oscillation classes expediently differ from one another. For example, one or more controller parameter adaptations are defined in controller parameter adaptation information, in particular in assignment to the respective oscillation classes. The controller parameter adaptation information is stored for example in the controller device 5. The controller device 5 is designed to carry out that controller parameter adaptation which is assigned to the respectively detected oscillation class.

Optionally, the controller device 5 is designed to carry out the controller parameter adaptation further in dependence on an oscillation characteristic, for example a spectrum, in particular a frequency, and/or an amplitude, of the detected oscillation 25.

Preferably, the controller device 5 is designed, as a response to a detection of at least one oscillation class and/or in dependence of the oscillation characteristic, for example the spectrum, in particular the frequency and/or the amplitude, of the detected oscillation 25, to carry out no controller parameter adaptation. For example, the controller device 5 is designed, on the basis of the oscillation class and/or the oscillation characteristic, to recognise that a controller parameter adaptation would not reduce (or even amplify) the oscillation of the controlled variable and in this case to carry out no controller parameter adaptation. The controller device 5 is preferably designed, as a response to a detection of the first oscillation class, to carry out a controller parameter adaptation, and as a response to a detection of a second oscillation class, to carry out no controller parameter adaptation.

The controller device 5 is preferably designed, as a response to a detection that the detected oscillation 25 is caused by the setpoint oscillation, not carry out the controller parameter adaptation.

The controller device 5 is preferably designed, as a response to a detection that the detected oscillation 25 is caused by the sensor noise, not carry out the controller parameter adaptation.

The controller device 5 is preferably designed, as a response to a detection that the detected oscillation 25 is caused by too low a stability reserve of the closed-loop control, to carry out the controller parameter adaptation according to the stability reserve oscillation class. The controller device 5 is preferably designed, on controller parameter adaptation according to the stability reserve oscillation class, to reduce at least one controller amplification, optionally several controller amplifications. Given oscillations of the stability reserve oscillation class, the controller as a rule is set too greatly, so that the controller amplification is to be reduced.

The controller device 5 is preferably designed, as a response to a detection that the detected oscillation 25 is caused by an external disturbance, to carry out the controller parameter adaptation according to the disturbance oscillation class. In particular, the controller device 5 is designed, given the controller parameter adaptation according to the disturbance oscillation class, to increase at least one controller amplification, optionally several controller amplifications. Given oscillations of the disturbance oscillation class, the controller as a rule is set too weakly, so that the controller amplification is to be increased.

The controller device 5 is preferably designed, on the basis of that setpoint and/or that controlled variable value (of the controlled variable 18) at which the controller device 5 has detected the oscillation 25, to define a controller parameter adaptation region for the setpoint and/or the controlled variable value. Optionally, the controller device 5 is designed to define the controller parameter adaptation region, in particular its size, in dependence on the detected oscillation class of the detected oscillation 25.

In particular, the controller device 5 is designed, as a response to the detected oscillation, to store the controller parameter adaptation region. The controller parameter adaptation region for example is a continuous value region or a tolerance region in which the setpoint and/or the controlled variable value lies, at which the oscillation 25 has occurred. The controller device 5 is expediently designed, for the further closed-loop control of the controlled variable 18 for setpoints and/or controlled variable values which lie within the controller parameter adaptation region 26, to use the at least one controller parameter which is adapted according to the controller parameter adaptation. Optionally, the controller device 5 is designed (in particular in a successive manner) to detect several oscillations of the controlled variable 18 at different setpoints and/or different controlled variable values and to define different controller parameter adaptation regions for these setpoints and/or controlled variable values. Optionally, a respective oscillation class and/or a respective controller parameter adaptation are assigned to each controller parameter adaptation region.

Preferably, the controller device 5 is designed to define a normal region 27 which lies outside the controller parameter adaptation region 26, and for the further closed-loop control of the controlled variable 18 for setpoints and/or controlled variable values which lie within the normal region 27, to use at least one controller parameter which is not adapted according to the controller parameter adaptation. The at least one controller parameter which is not adapted according to the controller parameter adaptation is for example a standard controller parameter. The controller parameter which is adapted according to the controller parameter adaptation is expediently different from the standard controller parameter. Optionally, the controller device 5 for the normal region 27 uses a standard controller parameter set with several controller parameters and for the controller parameter adaptation region 26 an adapted controller parameter set with several controller parameters which are adapted according to the controller parameter adaptation.

Expediently, the controller device 5 is designed to carry out a working point dependent intervention into one or more controller parameters. The working point is for example the setpoint and/or the controlled variable value, at which the oscillation 25 occurs. The controller device 5 in particular represents an adaptive controller. By way of example, the controller device 5 is designed, as a response to the detected oscillation 25, to reduce several controller amplifications on the working point. For example, the controller device 5 reduces one or more controller amplifications for setpoints which are close to the exhaust pressure. Expediently, the controller device 5, in particular an algorithm of the controller device 5 stores this reduction for a next setpoint setting which corresponds to the setpoints close to the exhaust pressure and/or is adjacent to these setpoints. Expediently, the controller device does not carry out the reduction for a regular working region—for example the normal region 27—and carries out the closed-loop control in this regular working region on the basis of one or more non-reduced controller amplifications.

FIG. 3 shows an illustratory picture with a temporal course of the controlled variable 18 and a temporal course of the setpoint signal 15. The time is plotted on the horizontal axis and the value of the controlled variable 18 and of the setpoint signal 15 on the vertical axis.

The setpoint signal 15 specifies a first setpoint 28. The controller device 5 closed-loop controls the controlled variable 18 to the first setpoint 28, in particular amid the use of the standard controller parameter. The controller device 5 detects no oscillation of the controlled variable 18 for the first setpoint 18 and accordingly carries out no classification of a detected oscillation and/or no controller parameter adaptation and/or no definition of a controller parameter adaptation region. The setpoint signal 15 specifies a second setpoint 29. The controller device 5 attempts to closed-loop control the controlled variable 18 to the second setpoint 29, in particular firstly amid use of the standard controller parameter. The oscillation of the controlled variable 18 occurs on closed-loop controlling to the second setpoint 29. The controller device 5 detects this oscillation 25 and carries out a classification of the oscillation 25 into one of the oscillation classes. The controller device 5 adapts the at least one controller parameter according to the classification of the oscillation 25 and continues the closed-loop control to the second setpoint 29 on the basis of the adapted controller parameter. The oscillation 25 is reduced, in particular eliminated by way of this. Expediently, the controller device 5 defines the controller parameter adaptation region 26 for the second setpoint 29 at which the oscillation 25 has occurred, so that the second setpoint 20 lies in the controller parameter adaptation region 26. The controller parameter adaptation region in particular is a continuous value region for the setpoint signal 15.

The setpoint signal 15 specifies a further setpoint 30 which can also be denoted as the third setpoint. The controller device 5 examines whether the further setpoint 30 lies within the controller parameter adaptation region 26. As a response to the controller device 5 recognising that the further setpoint 30 does not lie within the controller parameter adaptation region 26 (and expediently not within another controller parameter adaptation region), the controller device 5 uses the standard controller parameter in order to closed-loop control the controlled variable 18 to the further setpoint 30.

The setpoint signal 15 specifies a further setpoint 31 which can also be denoted as the fourth setpoint. The controller device 5 examines whether the further setpoint 31 lies within the controller parameter adaptation region 26. As a response to the controller device 5 recognising that the further setpoint 30 lies within the controller parameter adaptation region 26, the controller device 5 uses the adapted controller parameter which is specified for this controller parameter adaption region 26, in order to closed-loop control the controlled variable 18 to the further setpoint 30. No or only a recued oscillation of the controlled variable 18 occurs due to the use of the adapted controller parameter.

FIG. 4 shows a flow diagram of a method for the operation of the controller device 5 or the controller appliance 2.

The method comprises the step S 1 concerning which the controller device 5 provides a closed-loop control of the controlled variable 18 to the setpoint on the basis of the at least one controller parameter.

The method further comprises a step S2 concerning which the controller device 5 detects the oscillation 25 of the controlled variable 18.

The method further comprises a step S3 concerning which the controller device 5 classifies the detected oscillation 5 into one of several oscillation classes.

As a response to the detected oscillation 25 being classified into a first oscillation class, for example the stability reserve oscillation class and/or the disturbance oscillation class at the third step S3, the method continues with a step S4 concerning which the controller device 5 carries out the controller parameter adaptation of the at least one controller parameter according to the oscillation class of the detected oscillation 25. Expediently, the controller device 5 in the step S4 further defines the controller parameter adaptation region.

As a response to the detected oscillation 25 being classified into a second oscillation class, for example the setpoint oscillation class and/or the sensor noise oscillation class at the third step S3, the method continues with a step S5 concerning which the controller device 5 does not carry out the controller parameter adaptation and/or does not define the controller parameter adaptation region.

The method further comprises a step S6 concerning which the controller device 5, for a changed setpoint, examines whether the setpoint lies within a/the defined controller parameter adaptation region.

As a response to the controller device 5 in step S6 determining that the changed setpoint lies in a/the controller parameter adaptation region, the method continues with step S7 in which the controller device 5 uses the controller parameter which is adapted according to the controller parameter adaptation for the closed-loop control of the controlled variable 18 to the changed setpoint.

As a response to the controller device 5 in step S6 determining that the changed setpoint does not lie in the controller parameter adaptation region, the controller device 5 uses the standard controller parameter for the closed-loop control to the changed setpoint. The method then preferably continues with the step S2.

The controller device 5 is preferably operated outside its specification. Inasmuch as an oscillation (in particular outside the specification) occurs, this can be reduced or eliminated by the controller parameter adaptation.

Expediently, the controller device 5 represents a universal controller, in particular universal pressure controller, with an extended working region.

1-12. (canceled)

13. A controller device for automation technology, for the control of a valve device, in order to provide a closed-loop control of a controlled variable to a setpoint of a setpoint signal, wherein the controller device comprises at least one controller parameter on the basis of which the closed-loop control is effected, and wherein the controller device is designed to detect an oscillation of the controlled variable during the closed-loop control, to classify the detected oscillation into one of several oscillation classes and to carry out a controller parameter adaptation of the at least one controller parameter in dependence on the oscillation class into which the detected oscillation is classified, in order to reduce or eliminate the oscillation.

14. The controller device according to claim 13, wherein the several oscillation classes comprise a setpoint oscillation class and the controller device is designed to detect that the detected oscillation is caused by a setpoint oscillation, and as a response to this detection to classify the detected oscillation into the setpoint oscillation class and not to carry out the controller parameter adaptation.

15. The controller device according to claim 13, wherein the several oscillation classes comprise a sensor noise oscillation class, and the controller device is designed to detect that the detected oscillation is caused by a sensor noise, and as a response to this detection to classify the detected oscillation into the sensor noise oscillation class and not to carry out the controller parameter adaptation.

16. The controller device according to claim 13, wherein the several oscillation classes comprise a stability reserve oscillation class and the controller device is designed to detect that the detected oscillation is caused by too low a stability reserve of the closed-loop control, and as a response to this detection to classify the detected oscillation into the stability reserve oscillation class and to carry out the controller parameter adaptation according to the stability reserve oscillation class.

17. The controller device according to claim 16, wherein the controller device is designed to reduce at least one controller amplification for the controller parameter adaptation according to the stability reserve oscillation class.

18. The controller device according to claim 13, wherein the several oscillation classes comprise a disturbance oscillation class, and the controller device is designed to detect that the detected oscillation is created by an external disturbance, and as a response to this detection to classify the detected oscillation into the disturbance oscillation class and to carry out the controller parameter adaptation according to the disturbance oscillation class.

19. The controller device according to claim 18, wherein the controller device is designed to increase at least one controller amplification for the controller parameter adaptation according to the disturbance oscillation class.

20. The controller device according to claim 13, wherein the controller device is designed, on the basis of that setpoint and/or that controlled variable value of the controlled variable at which the controller device has detected the oscillation, to define a controller parameter adaptation region for the setpoint, and for the further closed-loop control of the controlled variable for setpoints and/or controlled variable values which lie within the controller parameter adaptation region, to use the at least one controller parameter which is adapted according to the closed-loop control adaptation.

21. The controller device according to claim 20, wherein the controller device is designed to define a normal region which lies outside the controller parameter adaptation region, and for the further closed-loop control of the controlled variable for setpoints and/or controlled variable values which lie within the normal region, to use at least one controller parameter which is not adapted according to the controller parameter adaptation.

22. The controller device according to claim 13, wherein the controlled variable comprises a pressure, a mass flow, a force and/or a position.

23. A controller appliance comprising a controller device according to claim 13 and the valve device.

24. A method for operating a controller device according to claim 13, comprising the steps:
providing the closed-loop control of the controlled variable to the setpoint on the basis of the at least one controller parameter,
detecting an oscillation of the controlled variable,
classifying the detected oscillation into one of several oscillation classes,
in dependence on the oscillation class, into which the detected oscillation is classified, carrying out the controller parameter adaptation.

25. The controller device according to claim 13, wherein the controller parameter is a controller amplification.
